(19) United States
(12) Patent Application Publication
(10) Pub. No.: US 2012/0313692 A1
(43) Pub. Date: Dec. 13, 2012

(54) SUPER-HIGH-VOLTAGE RESISTOR ON SILICON

(76) Inventors: Sehat Sutardja, Los Altos Hills, CA (US); Ravishanker Krishnamoorthy, Singapore (SG); Siew Yong Chui, Singapore (SG)

(21) Appl. No.: 13/467,648

(22) Filed: May 9, 2012

Related U.S. Application Data
(60) Provisional application No. 61/494,619, filed on Jun. 8, 2011.

(51) Int. Cl. G05F 3/02

(52) U.S. Cl. 327/535

(57) ABSTRACT

An integrated circuit (IC) including a first layer of a conducting material; a second layer of an insulating material, where the second layer has a first side arranged adjacent to the first layer, and a second side; and a substrate arranged adjacent to the second side of the second layer. A first well arranged in the substrate. The first well is adjacent to the second side of the second layer. The substrate and the first well have opposite doping.

### CROSS-REFERENCE TO RELATED APPLICATIONS

This application claims the benefit of U.S. Provisional Application No. 61/494,619, filed on Jun. 8, 2011. The disclosure of the above application is incorporated herein by reference in its entirety.

### FIELD

The present disclosure relates generally to integrated circuits and more particularly to integrating super-high-voltage resistors on silicon.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In some applications, a resistor in an integrated circuit (IC) may be subjected to a high voltage on an order of several hundred volts (e.g., an alternating current (AC) line voltage). While the resistor may be capable of withstanding the high voltage, an insulator that separates the resistor from a substrate of the IC may breakdown at a voltage less than the breakdown voltage of the resistor itself. Consequently, the voltage that can be effectively applied to the resistor may be less than the breakdown voltage of the resistor itself. In fact, the voltage that can be effectively applied to the resistor is less than the voltage at which the insulator may break down.

### SUMMARY

An integrated circuit (IC) comprises a first layer of a conducting material; a second layer of an insulating material, where the second layer has a first side arranged adjacent to the first layer, and a second side; and a substrate arranged adjacent to the second side of the second layer. A first well arranged in the substrate. The first well is adjacent to the second side of the second layer. The substrate and the first well have opposite doping.

In other features, the second layer has a breakdown voltage rating, and the second layer does not breakdown when a first voltage applied across the first layer is greater than or equal to the breakdown voltage rating of the second layer.

In other features, the substrate further comprises a third layer of the conducting material, wherein the third layer is connected to the first layer, a fourth layer of the insulating material, wherein the fourth layer has a first side arranged adjacent to the third layer, and a second side, and a second well arranged in the substrate. The second well is adjacent to the second side of the fourth layer, and the substrate and the second well have opposite doping.

In other features, the first well is connected to a junction of the first layer and the third layer.

In other features, the first well is connected to a first voltage having a value less than a second voltage applied across the first layer and the third layer.

In other features, the first well is connected to a first voltage, and the second well is connected to a second voltage. Each of the first voltage and the second voltage is less than a third voltage applied across the first layer and the third layer.

In other features, at least one of the first well and the second well is connected to a voltage point internal to the IC.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is a cross-sectional view of an integrated circuit comprising a resistor;

FIG. 2 is a cross-sectional view of an integrated circuit comprising a resistor with a well arranged in a substrate;

FIG. 3 depicts an overlay of electrical equivalents of the resistor of FIG. 2 on top of the cross-sectional view shown in FIG. 2;

FIG. 4A is a cross-sectional view of an integrated circuit comprising a resistor with a plurality of wells arranged in a substrate;

FIG. 4B depicts an overlay of electrical equivalents of the resistor of FIG. 4A on top of the cross-sectional view shown in FIG. 4A;

FIG. 4C is a cross-sectional view of an integrated circuit comprising a resistor with a plurality of wells arranged in a substrate, where a well is tied to a polysilicon layer;

FIG. 4D is a cross-sectional view of an integrated circuit comprising a resistor with a plurality of wells arranged in a substrate, where a well is tied to a bias voltage;

FIGS. 5A-5D depict different ways of connecting wells to voltage points internal to a resistor; and

FIG. 6 is a flowchart of a method for applying a voltage to a resistor that is greater than a breakdown voltage of an insulator used to form the resistor without breaking down the resistor.

### DESCRIPTION

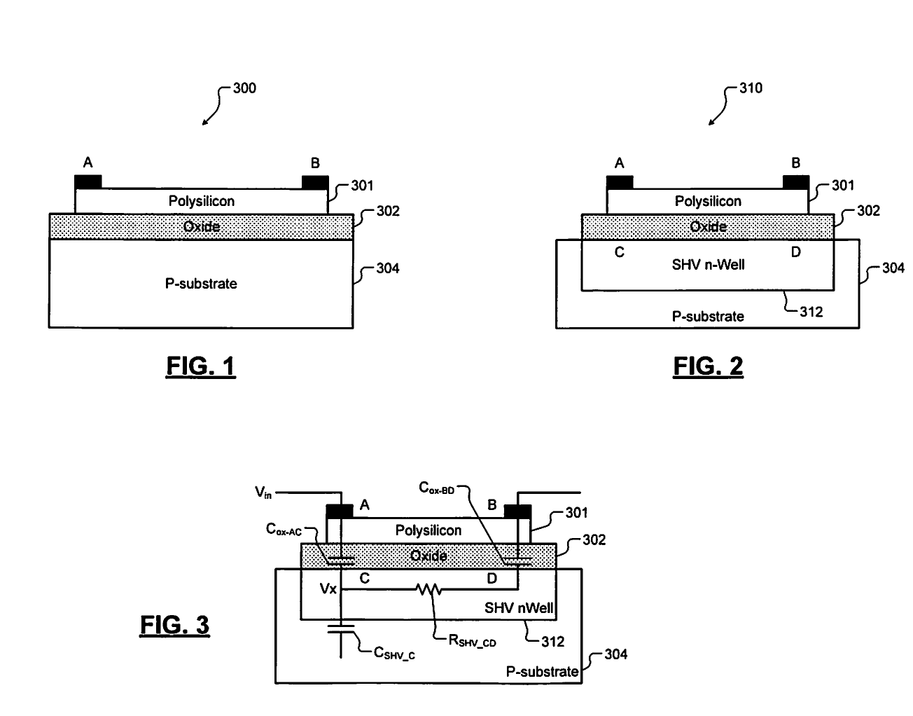

Referring now to FIG. 1, a cross-sectional view of a super-high voltage (SHV) resistor 300 implemented on silicon is shown. The resistor 300 includes a layer of polysilicon (or metal) 301 that is realized on top of an oxide layer 302. The oxide layer 302 insulates the polysilicon layer 301 from a substrate 304, which is typically connected to ground. The substrate 304 is shown as p-type for example only, and the substrate 304 can be n-type instead. The resistor 300 has two terminals A and B for connecting the resistor 300 to other circuits.

Suppose that a very high voltage on the order of several hundred volts (e.g., the AC line voltage) is applied to terminal A of the resistor 300, and terminal B of the resistor 300 is connected to ground. A maximum value of the voltage that can be applied across the resistor 300 depends on factors including breakdown voltages of the polysilicon layer 301 and the oxide layer 302. The breakdown voltage of the oxide layer 302 is generally less than the breakdown voltage of the polysilicon layer 301. Therefore, the maximum value of the voltage that can be applied across the resistor 300 is typically limited by the breakdown voltage of the oxide layer 302.

Specifically, when the voltage applied across the resistor 300 is increased, a leakage current starts flowing through the oxide layer 302. The leakage current increases as the voltage applied across the resistor 300 approaches the breakdown voltage of the oxide layer 302. When the voltage applied across the resistor 300 becomes equal to the breakdown voltage, the leakage current is high enough to damage the oxide layer 302. Therefore, a voltage greater than the breakdown voltage of the oxide layer 302 cannot be applied across the resistor 300.

The breakdown voltage of the oxide layer 302 is proportional to a thickness of the oxide layer 302. Therefore, one way to increase the value of the voltage that can be applied across the resistor 300 is to increase the thickness of the oxide layer 302. Increasing the thickness of the oxide layer 302, however, may not be feasible in a semiconductor process used to manufacture ICs. The oxide layer 302 in most currently manufactured resistors breaks down at about 300-400 volts. Accordingly, most currently manufactured resistors can withstand approximately 300-400 volts.

The resistors described below include a super-high voltage (SHV) well in the substrate of the resistor. The SHV well allows application of voltages greater than the breakdown voltage of the oxide layer (i.e., greater than 300-400 volts) across the resistor. Voltages greater than the breakdown voltage of the oxide layer can be applied across the resistor without increasing the thickness of the oxide layer.

Referring now to FIG. 2, a resistor 310 including a super-high voltage (SHV) n-well is shown. The resistor 310 includes the polysilicon (or metal) layer 301, the oxide layer 302, the p-substrate 304, and a super-high voltage (SHV) n-Well 312. The resistor 310 can operate at a voltage greater than the breakdown voltage of the oxide layer 302 due to the SHV n-Well 312 placed in the p-substrate below the oxide layer 302. Again, a p-type substrate including the n-Well is shown for a case when voltage at node A is higher than the voltage at node B. A p-Well is to be used if the substrate is n-type, and the voltage at node A is lower than the voltage at node B. The effective breakdown voltage of the resistor 310 (i.e., a voltage at which the oxide layer 302 breaks down) is equal to a sum of the breakdown voltages of the oxide layer 302 and the SHV n-Well 312.

In FIG. 3, an overlay of an electrical equivalent of the resistor 310 on top of the cross-section of the resistor 310 is shown. Letters C and D denote regions of the SHV n-Well 312 that are adjacent to the oxide layer 302 and that are directly below terminals A and B of the resistor 310, respectively. A capacitor Cₒₓ_{_{—}}_{AC} represents a capacitance between terminal A of the polysilicon layer 301 and the region C of the SHV n-Well 312. A capacitor C_{SHV}_{_{—}}_{C} represents a capacitance between the region C of the SHV n-Well 312 and the p-substrate 304. A capacitor Cₒₓ_{_{—}}_{BD} represents a capacitance between terminal B of the polysilicon layer 301 and the region D of the SHV n-Well 312. A resistor R_{SHV}_{_{—}}_{CD} represents a resistance of the SHV n-Well 312 between the regions C and D. The resistor R_{SHV}_{_{—}}_{CD} is very high. Therefore, the capacitors Cₒₓ_{_{—}}_{AC} and C_{SHV}_{_{—}}_{C}, which are connected in series, act as a voltage divider. Vx denotes a potential at a junction of the capacitors Cₒₓ_{_{—}}_{AC} and C_{SHV}_{_{—}}_{C}.

A voltage applied at terminal A, (e.g., Va) is the voltage applied across the resistor 310 since terminal B of the resistor 310 is at ground potential. Additionally, the p-substrate 304 is at ground potential. Therefore, when Va is initially applied across the resistor 310, the SHV n-Well 312 is at ground potential (same as the p-substrate 304). When Va nears a rated breakdown voltage of the oxide layer 302, the oxide layer 302 starts conducting a small leakage current. This leakage current charges the capacitor C_{SHV}_{_{—}}_{C}, which increases the potential of the SHV n-Well 312. The increased potential of the SHV n-Well 312 decreases the effective potential across the oxide layer 302 less than the voltage Va applied across the resistor 310.

The voltages of the capacitors Cₒₓ_{_{—}}_{AC} and C_{SHV}_{_{—}}_{C} are inversely proportional to the leakage currents of the capacitors Cₒₓ_{_{—}}_{AC} and C_{SHV}_{_{—}}_{C}. Assuming that the capacitors Cₒₓ_{_{—}}_{AC} and C_{SHV}_{_{—}}_{C} are equal, since the resistor R_{SHV}_{_{—}}_{CD} is very high, the capacitors Cₒₓ_{_{—}}_{AC} and C_{SHV}_{_{—}}_{C}, which are connected in series, act as a voltage divider that divides the voltage Va by two. Accordingly, the voltage Vx at the junction of the capacitors Cₒₓ_{_{—}}_{AC} and C_{SHV}_{_{—}}_{C} is Va/2.

Therefore, when Va reaches the rated breakdown voltage of the oxide layer 302, the effective voltage across the oxide layer 302 is approximately half of the rated breakdown voltage of the oxide layer 302, which prevents the oxide layer 302 from breaking down. Theoretically, the voltage at which the oxide layer 302 will in fact break down is approximately doubled. Therefore, a voltage equal to twice the rated breakdown voltage of the oxide layer 302 can be theoretically applied across the resistor 310 before the oxide layer 302 can break down.

Practically, the oxide layer 302, being an insulator, has a smaller leakage current than the doped SHV n-Well 312. Consequently, the capacitors Cₒₓ_{_{—}}_{AC} and C_{SHV}_{_{—}}_{C} do not divide the voltage across terminal A and the p-substrate 304 (i.e., the voltage across the resistor 310), and Vx is not equal to Va/2. Rather, since the oxide layer 302 has a smaller leakage current than the SHV n-Well 312, the voltage across the capacitor capacitors Cₒₓ_{_{—}}_{AC} and consequently the voltage across the oxide layer 302 is greater than Va/2. The oxide layer 302 therefore can break down at a lower voltage than twice the rated breakdown voltage of the oxide layer 302.

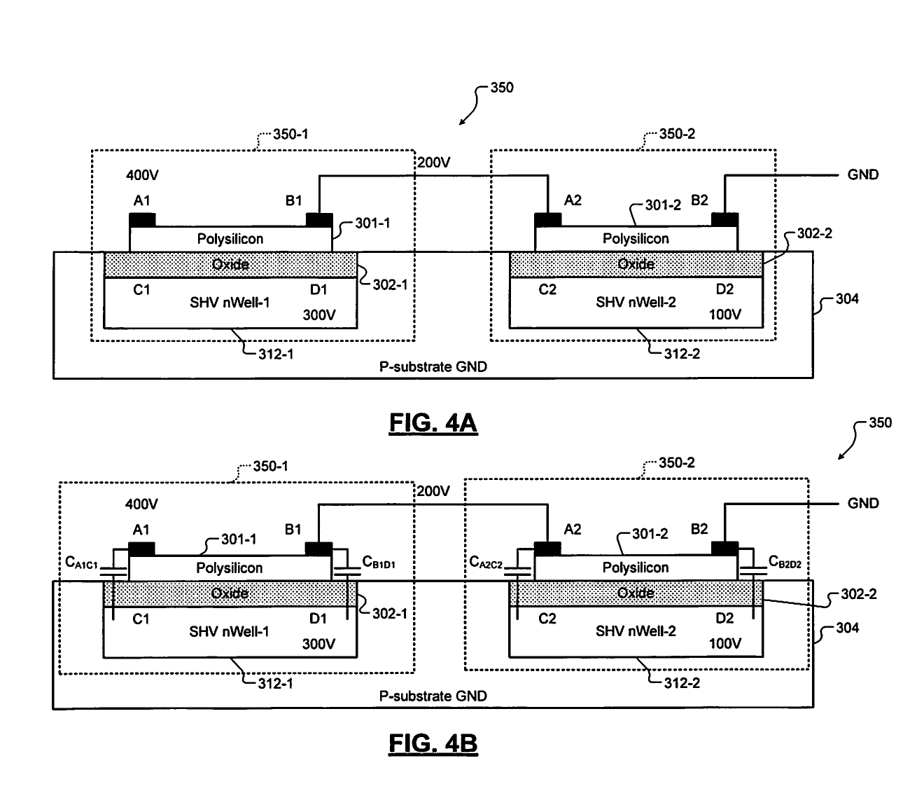

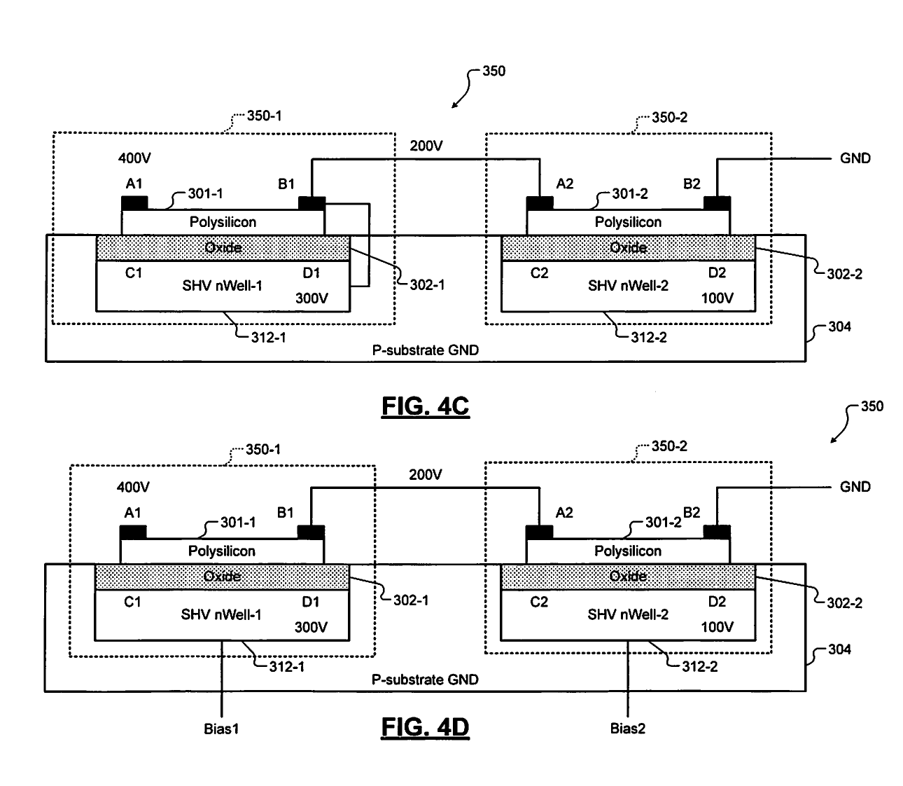

Referring now to FIGS. 4A and 4B, a resistor 350 having split wells within the same substrate is shown. In FIG. 4A, cross-sectional view of the resistor 350 is shown. The resistor 350 is essentially split into two resistors: a first resistor 350-1 and a second resistor 350-2. The first resistor 350-1 includes a first polysilicon (or metal) layer 301-1, a first oxide layer 302-1, and a first SHV n-Well-1 312-1 in the p-substrate 304. The first resistor 350-1 has two terminals A1 and B1. Letters C1 and D1 denote regions of the first SHV n-Well-1 312-1 that are adjacent to the first oxide layer 302-1 and that are directly below terminals A1 and B1 of the first resistor 310-1, respectively.

The second resistor 350-2 includes a second polysilicon (or metal) layer 301-2, a second oxide layer 302-2, and a second SHV n-Well-2 312-2 in the p-substrate 304. The second resistor 350-2 has two terminals A2 and B2. Letters C2 and D2 denote regions of the second SHV n-Well-2 312-2 that are adjacent to the second oxide layer 302-2 and that are directly below terminals A2 and B2 of the second resistor 310-2, respectively.

In FIG. 4B, an overlay of an electrical equivalent of the resistor 350 on top of the cross-section of first resistor 350 is shown. The first resistor 350-1 effectively includes two capacitors: a first capacitor C_{A1C1} between terminal A1 and region C1, and a second capacitor C_{B1D1} between terminal B1 and region D1. The first capacitor C_{A1C1} represents a capacitance between terminal A1 of the polysilicon layer 301-1 and the region C1 of the first SHV n-Well-1 312-1. The second capacitor C_{B1D1} represents a capacitance between terminal B1 of the polysilicon layer 301-1 and the region D1 of the first SHV n-Well-1 312-1. A well capacitance between the first SHV n-Well-1 312-1 and the p-substrate 304 is negligible and therefore not shown.

The capacitances of the first capacitor C_{A1C1} and the second capacitor C_{B1D1} are nearly the same because the materials that form the first capacitor C_{A1C1} and the second capacitor C_{B1D1} are the same. Specifically, the same first oxide layer 302-1 forms the dielectric of both the first capacitor C_{A1C1} and the second capacitor C_{B1D1}. The leakage current through both the first capacitor C_{A1C1} and the second capacitor C_{B1D1} is therefore nearly the same.

Similarly, the second resistor 350-2 effectively includes two capacitors: a first capacitor C_{A2C2} between terminal A2 and region C2, and a second capacitor C_{B2D2} between terminal B2 and region D2. The first capacitor C_{A2C2} represents a capacitance between terminal A2 of the polysilicon layer 301-2 and the region C2 of the second SHV n-Well-2 312-2. The second capacitor C_{B2D2} represents a capacitance between terminal B2 of the polysilicon layer 301-2 and the region D2 of the second SHV n-Well-2 312-2. A well capacitance between the second SHV n-Well-2 312-2 and the p-substrate 304 is negligible and therefore not shown. The capacitances of the first capacitor C_{A2C2} and the second capacitor C_{B2D2} are nearly the same.

When a voltage is applied across the resistor 350, the voltage is applied across the terminals A1 and B2. Suppose for simplicity of discussion that terminal B2 is connected to ground. Additionally, the p-substrate 304 is connected to ground. When a voltage, (e.g., Va) is applied at terminal A1 (i.e., across the terminals A1 and B2 of the resistor 350), the first resistor 350-1 and the second resistor 350-2 divide the voltage Va, and the voltage at terminals B1 and A2 is Va/2.

Now suppose, for example only, that the voltage applied across the resistor 350 (i.e., at terminal A1, with terminal B2 connected to ground), is Va=400V. The voltage at terminal B1 is Va/2=200V because the first resistor 350-1 and the second resistor 350-2 acts as a voltage divider connected between terminals A1 and B2 of the resistor 350. The voltage between terminals A1 and B1 is (400V−200V)=200V. The voltage between terminals A2 and B2 is (200V−0V)=200V.

In the first resistor 350-1, the first capacitor C_{A1C1} and the second capacitor C_{B1D1}; which are nearly equal in value, and which are effectively connected in series, act as a voltage divider connected between terminals A1 and B1. The potential of the first SHV n-Well-1 312-1 is therefore 300V. The effective voltage across the first oxide layer 302-1 near terminal Al and region C1 is the difference between the voltage Va at terminal A1 and the potential of the first SHV n-Well-1 312-1, which is (400V-300V)=100V. The effective voltage across the first oxide layer 302-1 near terminal B1 and region D1 is the difference between the voltage at terminal B1, which is Va/2 (200V), and the potential of the first SHV n-Well-1 312-1, which is 300V. That is, the effective voltage across the first oxide layer 302-1 near terminal B1 and region D1 is also 100V.

Similarly, in the second resistor 350-2, the voltage at terminal A2 is Va/2 or 200V, and terminal B2 is grounded. The potential of the second SHV n-Well-2 312-2 is equal to a potential difference between terminals A2 and B2 divided by two, which is (200V−0V)/2=100V. The effective voltage across the second oxide layer 302-2 near terminal A2 and region C2 is the difference between the voltage at terminal A2, which is Va/2 (200V), and the potential of the second SHV n-Well-2 312-2 (100V). That is, the effective voltage across the second oxide layer 302-2 near terminal A2 and region C2 is 100V. The effective voltage across the second oxide layer 302-2 near terminal B2 and region D2 is the difference between the voltage at terminal B2, which is 0V, and the potential of the second SHV n-Well-2 312-2, which is 100V. That is, the effective voltage across the second oxide layer 302-2 near terminal B2 and region D2 is also 100V.

As another example, if Va=800V, with terminal B2 grounded, the voltage at terminal B1 may be 400V. The potential of the first SHV n-well-1 312-1 may be 600V, and the potential of the second SHV n-well-2 312-2 may be 200V. Accordingly, the effective voltages across the first oxide layer 302-1 and the second oxide layer 302-2 near terminal A1 and region C1, near terminal B1 and region D1, near terminal A2 and region C2, and near terminal B2 and region D2 will be 200V.

Thus, because the resistor 350 is split into two resistors each having a well and because terminal B1 of the first resistor 350-1 is at a potential greater than the ground potential, the effective voltages across the oxide layer 302-1 near terminals A1, B1 and regions C1, D1 and the effective voltages across the second oxide layer 302-2 near terminals A2, B2 and regions C2, D2 are one-fourth of the voltage applied across the resistor 350. In other words, a voltage of approximately four times the rated breakdown voltage of the oxide layer 302 can be applied across the resistor 350.

Additionally, because the potential of the SHV n-well 312 can be increased to values greater than those shown in the above examples, the actual voltage that can be applied across the resistor 350 can be greater than four times the rated breakdown voltage of the oxide layer 302. The maximum value of the voltage that can be applied to the resistor 350 without causing a breakdown of the oxide layer 302 is limited to a sum of the rated breakdown voltage of the oxide layer 302 and a well-to-substrate breakdown voltage.

All voltage values mentioned in the disclosure are for example only. Actual values of voltages will depend on various factors. The factors may include the thickness of oxide layer 302; the doping levels of the SHV wells 312 and the substrate 304; the leakage currents of the oxide layer 302, the SHV wells 312, and the substrate 304; the areas of the SHV wells 312; the number of wells in the substrate 304, and so on.

Practically, depending on the semiconductor process used to manufacture the resistor 350, the capacitance between terminal A1 and region C1 may not be equal to the capacitance between terminal B1 and region D1, and the capacitance between terminal A2 and region C2 may not be equal to the capacitance between terminal B2 and region D2. Further, the well capacitances may not be negligible.

Referring now to FIG. 4C, one way to eliminate the uncertainties introduced by the reliance on the capacitances, and to know the well potentials with certainty independently of the uncertainties, is to tie at least the first SHV n-well-1 312-1 to terminal B1. Since the value of the voltage Va applied across the resistor 350 and the values of the resistances of the first resistor 350-1 and the second resistance 350-2 are known, the value of the voltage at terminal B1 (e.g., Va/2) is known. Tying the first SHV n-well-1 312-1 to terminal B1 therefore eliminates any uncertainty that may be introduced by the capacitances in determining the maximum value of the voltage that can be applied across the resistor 350 without breaking down the oxide layer 302.

In some implementations, while not shown, the resistor 350 can be split into more than two resistors. For example, suppose that the resistor 350 is split into three resistors: a first resistor 350-1, a second resistor 350-2, and a third resistor 350-3. The first resistor 350-1 may have terminals A1 and B1; the second resistor 350-2 may have terminals A2 and B2; and the third resistor 350-3 may have terminals A3 and B3. Terminal B1 is connected to terminal A2, and terminal B2 is connected to terminal A3. Voltage applied across the resistor 350 is applied across terminals A1 and B3. Each of the first, second, and third resistors may include a well. The well of the first resistor 350-1 can be tied to terminal B1, terminal B2, or terminal B3 if terminal B3 is not grounded. The well of the second resistor 350-2 can be tied to terminal B2 or terminal B3 if terminal B3 is not grounded. With three resistors 350-1, 350-2, and 350-3, the voltage drop or field potential across each resistor is approximately the voltage at terminal A1, Va, divided by three (3). In general, with N resistors, the voltage drop or field potential across each resistor is approximately the voltage at terminal A1, Va, divided by the number of resistors N, Va/N.

In some implementations, depending on the resistance of the resistor 350 and the voltage applied across the resistor 350, the current flowing through the resistor 350 may be on the order of the leakage currents flowing through the oxide layer 302. In FIG. 4C, for example, if the first SHV n-well-1 312-1 is tied to terminal B1, the current flowing through the resistor 350 from terminals A1 to B1 may find a path from terminal B1 to ground via the well capacitance of the first SHV n-well-1 312-1. This may affect the voltage divider formed by the first resistor 350-1 and the second resistor 350-2.

Referring now to FIG. 4D, a well of the resistor 350 may be tied to a known bias voltage generated by a source external to the resistor 350 instead of tying the well of the resistor 350 to a terminal of a corresponding resistor. For example, the well may be tied to an alternate voltage divider that is independent of the voltage divider formed by the first resistor 350-1 and the second resistor 350-2 of the resistor 350. For example, as shown, the first SHV n-well-1 312-1 may be tied to a first bias voltage Bias1, and the second SHV n-well-2 312-2 may be tied to a second bias voltage Bias2. The first and second bias voltages Bias1 and Bias2 may be same or different. Depending on the number of wells to be connected to known voltages, the voltage divider can have a plurality of resistances connected in series to generate a plurality of known bias voltages. In another example, the source external to the resistor 350 that is used to provide the known bias voltage is a voltage source that supplies the highest voltage level within the circuit arrangement that utilizes the resistor 350.

Alternatively, as explained below, the first SHV n-well-1 312-1 of the first resistor 350-1 may be tied to a voltage point internal to the first resistor 350-1 instead of being tied to a terminal of a corresponding resistor. Similarly, the second SHV n-well-2 312-2 of the second resistor 350-2 may be tied to a voltage point internal to the second resistor 350-2 instead of being tied to a terminal of a corresponding resistor.

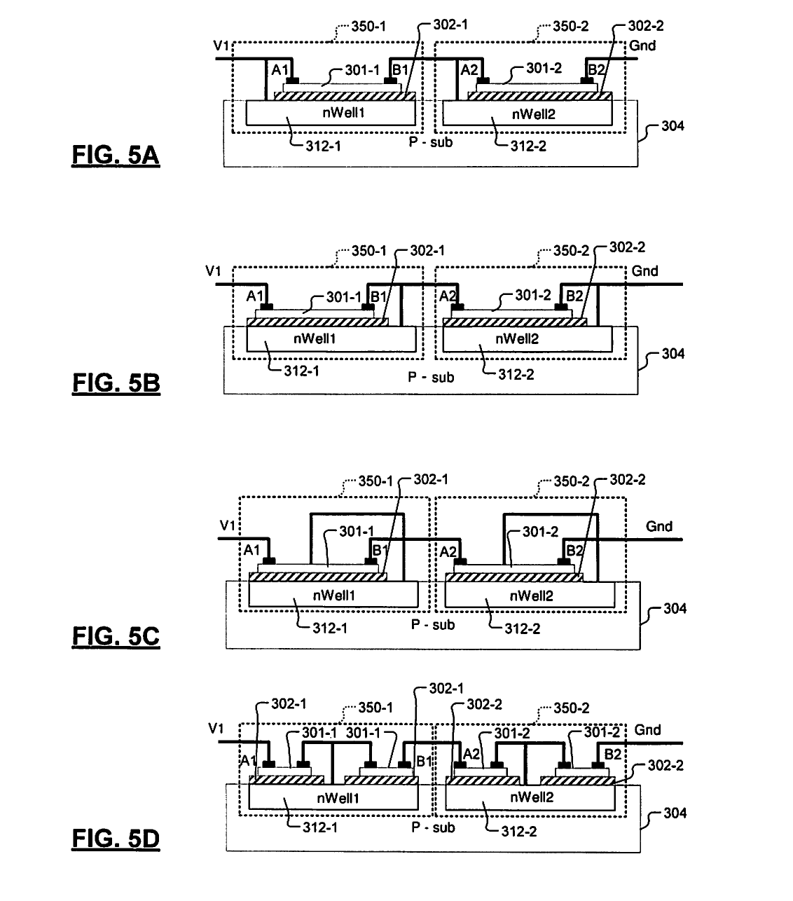

Referring now to FIGS. 5A-5D, the wells can be tied to voltage points internal to the resistors in many ways. In FIG. 5A, the wells are connected to a first terminal of the respective resistors, where the first terminal is at a higher potential than a second terminal of the resistor. For example, the first SHV n-well-1 312-1 is connected to the terminal A1 of the first resistor 350-1, where the terminal A1 of the first resistor 350-1 is at a higher potential than the terminal B1 of the first resistor 350-1. Similarly, the second SHV n-well-2 312-2 is connected to the terminal A2 of the second resistor 350-2, where the terminal A2 of the second resistor 350-2 is at a higher potential than the terminal B2 of the second resistor 350-2.

In FIG. 5B, the wells are connected to the second terminal of the respective resistors, where the second terminal is at a lower potential than the first terminal of the resistor. For example, the first SHV n-well-1 312-1 is connected to the terminal B1 of the first resistor 350-1, where the terminal B1 of the first resistor 350-1 is at a lower potential than the terminal A1 of the first resistor 350-1. Similarly, the second SHV n-well-2 312-2 is connected to the terminal B2 of the second resistor 350-2, where the terminal B2 of the second resistor 350-2 is at a lower potential than the terminal A2 of the second resistor 350-2.

In FIG. 5C, the wells are connected to a point (e.g., a midpoint) between the first and second terminals of the respective resistors so that the wells potential is between the voltages of the first and second terminals of the respective resistors. For example, in the first resistor 350-1, the first SHV n-well-1 312-1 is connected to the first polysilicon layer 301-1 at a point between the terminals A1 and B1 of the first resistor 350-1. The potential of the first SHV n-well-1 312-1 is between the voltage at the terminal A1 and the voltage at the terminal B1 of the first resistor 350-1. Similarly, in the second resistor 350-2, the second SHV n-well-2 312-2 is connected to the second polysilicon layer 301-2 at a point between the terminals A2 and B2 of the second resistor 350-2. The potential of the second SHV n-well-2 312-2 is between the voltage at the terminal A2 and the voltage at the terminal B2 of the second resistor 350-2.

In FIG. 5D, the resistors may be split into a plurality of resistors, and the wells may be tied to a voltage point between one of the plurality of resistors. For example, the first resistor 350-1 may be split into two (or more) resistors as shown, and the first SHV n-well-1 312-1 may be tied to a voltage point between the two resistors (or any two resistors, if the second resistor 350-2 is split into more than two resistors). Similarly, the second resistor 350-2 may be split into two (or more) resistors as shown, and the second SHV n-well-2 312-2 may be tied to a voltage point between the two resistors (or any two resistors, if the second resistor 350-2 is split into more than two resistors).

In general, the wells of the resistor 350 may be connected to a bias voltage having a known value that is less than the voltage applied across the resistor 350 so that the maximum value of the voltage that can be applied across the resistor 350 without breaking down the oxide layer 302 can be calculated. One or more wells of the resistor 350 can be connected to the same or different known voltages or can be left floating (i.e., not connected to a known potential). Any combination of these schemes to bias or not bias the wells of the resistor 350 may be used.

In summary, the voltage applied across the resistor 350 is split into at least two components: a first component that is applied across the oxide layer 302 and a second component that is applied across at least one of the wells. Such a configuration of the resistor 350 prevents the oxide layer 302 from breaking down at the rated breakdown voltage of the oxide layer 302. The configuration allows voltages greater than the rated breakdown voltage of the oxide layer 302 to be applied across the resistor 350 without causing the oxide layer 302 to break down at the rated breakdown voltage.

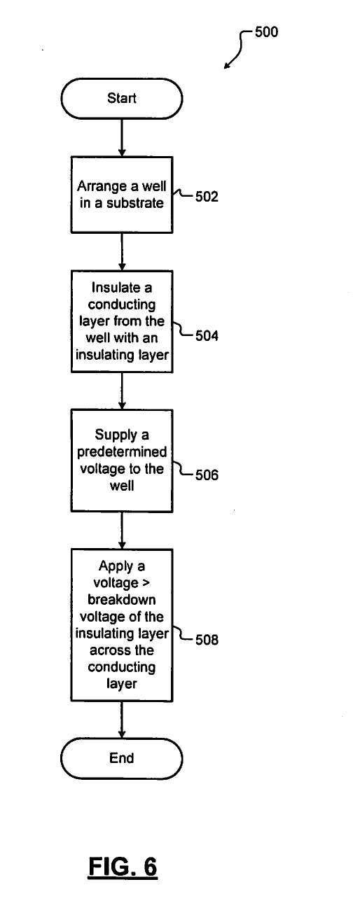

Referring now to FIG. 6, a flowchart of a method 500 for applying a voltage to a resistor that is greater than a breakdown voltage of an insulator used to form the resistor without breaking down the resistor is shown. At 502, a well is arranged in a substrate, where the well and the substrate have opposite doping. At 504, a conducting layer of the resistor is insulated from the well with an insulating layer having a breakdown voltage. At 506, a predetermined voltage is optionally supplied to the well. At 508, a voltage greater than the breakdown voltage is applied across the conducting layer without breaking down the insulating layer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

1. An integrated circuit (IC), comprising:
a first layer of a conducting material;
a second layer of an insulating material, wherein the second layer has a first side arranged adjacent to the first layer, and a second side;
a substrate arranged adjacent to the second side of the second layer; and
a first well arranged in the substrate;
wherein the first well is adjacent to the second side of the second layer,
wherein the substrate and the first well have opposite doping, and
wherein the first well, is connected to 3 voltage source supplying a predetermined voltage.

2. The IC of claim 1, wherein the second layer has a breakdown voltage rating, and wherein the second layer does not breakdown when a first voltage applied across the first layer is greater than or equal to the breakdown voltage rating of the second layer.

3. The IC of claim 1, wherein the substrate further comprises:
a third layer of the conducting material, wherein the third layer is connected to the first layer;
a fourth layer of the insulating material, wherein the fourth layer has a first side arranged adjacent to the third layer, and a second side; and
a second well arranged in the substrate,
wherein the second well is adjacent to the second side of the fourth layer, and
wherein the substrate and the second well have opposite doping.

4. The IC of claim 3, wherein the voltage source supplying the predetermined voltage is the first layer.

5. The IC of claim 3, wherein the predetermined is less than a second voltage applied across the first layer and the third layer.

6. The IC of claim 3, wherein the second well is connected to a second voltage, and wherein each of the predetermined voltage and the second voltage is less than a third voltage applied across the first layer and the third layer.

7. The SC of claim 8, wherein the predetermined voltage and the second voltage are equal.

8. The IC of claim 3, wherein the voltage source supplying the predetermined voltage is a voltage point internal to the IC, and wherein the second well is connected to the voltage point internal to the IC.

9. The IC of claim 2,, wherein the first voltage applied across the first layer is on the order of several hundred volts.

10. The IC of claim 1, wherein:
the first layer is a layer of polysilicon,
the second layer is an oxide layer, and
the first weft is a super-high voltage well.

11. The IC of claim 1, wherein the predetermined voltage is a bias voltage.

12. An integrated circuit (IC), comprising:
a plurality of resistors connected In series;
wherein the plurality of resistors shares a common substrate;
wherein each of the plurality of resistors includes a conducting layer, an insulating layer, and a super-high voltage well;
wherein the insulating layer is disposed between the conducting layer and the super-high voltage well; and
wherein the super-high voltage well is connected to a voltage source supplying a predetermined voltage.

13. The IC of claim 12, wherein:
the insulating layer has a first side arranged adjacent to the conducting layer, and a second side;
the substrate is arranged adjacent to the second side of the insulating layer;
the super-high voltage well is arranged in the substrate;
the super-high voltage well is adjacent to the second side of the insulating layer; and
the substrate and the super-high voltage well have opposite doping.

14. The IC of claim 12, wherein the insulating layer has a breakdown voltage rating, and wherein the insulating layer does not breakdown when a first voltage applied across the conducting layer is greater than or equal to the breakdown voltage rating of the insulating layer.

15. The IC of claim 12, wherein:
a first resistor of the plurality of resistors comprises a first conducting layer, a first insulating layer,, and a first super-high voltage well;
a second resistor of the plurality of resistors comprises a second conducting layer, a second insulating layer, and a second super-high voltage well; and
the second conducting layer is connected to the first conducting layer.

16. The IC of claim 15, wherein the first super-high voltage well is connected to the voltage source supplying the predetermined voltage, and wherein the voltage source supplying the predetermined voltage is the first conducting layer.

17. The IC of claim 15, wherein the first super-high voltage well is connected to the voltage source supplying the predetermined voltage, and wherein the predetermined voltage is less than a second voltage applied across the first conducting layer and the second conducting layer.

18. The IC of claim 15, wherein the first super-high voltage well is connected to the voltage source supplying the predetermined voltage, wherein the second super-high voltage well is connected to a second voltage, and wherein each of the predetermined voltage and the second voltage is less than a third voltage applied across the first conducting layer and the second conducting layer.

19. The IC of claim 18, wherein the predetermined voltage and the second voltage are equal.

20. The IC of claim 15, wherein at least one of the first super-high voltage well and the second super-high voltage well is connected to the voltage source supplying the predetermined voltage, and wherein the voltage source supplying the predetermined voltage is a voltage point internal to the IC.

21. The SC of claim 14, wherein the first voltage applied across the conducting layer is on the order of several hundred volts.

22. The IC of claim 12, wherein:
the conducting layer is a layer of polysilicon,
the insulating layer is an oxide layer.

23. The IC of claim 12, wherein the predetermined voltage is a bias voltage.

24. A method, comprising:
arranging a super-high voltage well in a substrate, wherein the substrate and the super-high voltage well have opposite doping;
insulating a conducting layer from the super-high voltage well with an insulating layer having a breakdown voltage;
applying a voltage greater than the breakdown voltage across the conducting layer without breaking down the insulating layer; and
connecting the super-high voltage well to a voltage source supplying a predetermined voltage.

25. (canceled)
